(19) United States
(12) Patent Application Publication
(10) Pub. No.: US 2010/0027177 A1
(43) Pub. Date: Feb. 4, 2010

(54) Thyristor Valve of an HVDC Transmission System

(75) Inventors: Hartmut Huang, Erlangen (DE); Marcus Häusler, Erlangen (DE); Markus Uder, Gerhardshofen (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, München (DE)

(21) Appl. No.: 12/443,495

(22) PCT Filed: Sep. 27, 2007
(86) PCT No.: PCT/EP2007/060276

§ 371 Date: Mar. 30, 2009

(30) Foreign Application Priority Data
Sep. 28, 2006 (DE) 10 2006 046 040.5

(51) Int. Cl. H02H 9/04

(52) U.S. Cl. 361/91.8

(57) ABSTRACT

A valve of a converter of a high-voltage direct current transmission system has a plurality of valve sections, each comprising a plurality of thyristors electrically connected in series, and a surge arrester, which is electrically connected in parallel to the valve. According to the invention, a surge arrester is connected electrically in parallel to each valve section. Thus a thyristor valve of a converter of a high-voltage direct current transmission system is obtained, which does not require control capacitors.

The invention relates to a valve of a converter of a high-voltage direct-current transmission system having a plurality of valve sections which each have a plurality of thyristors which are electrically connected in series, and having a surge arrester, which is electrically connected in parallel with the valve.

A thyristor valve such as this of a high-voltage direct-current transmission system, also called an HVDC transmission system is known from the publication entitled “Modern HVDC Thyristor Valves for China's Electric Power System” printed in . . . . An HVDC transmission system is used to couple two electrical power supply systems with a different frequency behavior to one another in order to exchange energy. In order to allow a required voltage blocking capability to be achieved, a valve of a converter for an HVDC transmission system has a multiplicity of thyristors. This multiplicity of thyristors of a thyristor valve is split between a plurality of valve sections. Two valve sections of a thyristor valve in each case form a thyristor module. If one phase of a converter in an HVDC transmission system has four thyristor valves and each thyristor valve is formed from three thyristor modules, then this phase has twelve thyristor modules, which are split between two valve towers, which are arranged physically parallel. Each thyristor module forms one level of a valve tower such as this.

A surge arrester is electrically connected in parallel with each thyristor valve. The valves are each protected against overvoltages by means of these parallel-connected surge arresters, provided that an overvoltage occurs uniformly in all the units within one valve. If, when overvoltages with high voltage gradients occur, caused by existing stray capacitances or stray capacitances which differ depending on the valve section under consideration, an unbalanced voltage distribution occurs within a thyristor valve, then thyristors in one valve section can be loaded beyond their reverse blocking capability in one valve section with proportionally the highest overvoltage, and can in this case be destroyed.

In order to prevent this, according to the publication cited initially, so-called control capacitors are used in each valve section of a valve, for voltage balancing. These control capacitors are electrically connected in parallel with a respective valve section. In consequence, each thyristor module, which has two valve sections, has two control capacitors. The value of each control capacitor must be chosen to be sufficiently high that the voltage distribution is governed by it and not by any existing stray capacitance. A typical value for a control capacitor in a 500 kV HVDC transmission valve is 6 nF per valve section. A control capacitor such as this occupies a not inconsiderable space in a thyristor module. Furthermore, these control capacitors increase the weight of the thyristor module.

The invention is now based on the object of developing a valve of this generic type such that control capacitors are no longer required.

According to the invention, this object is achieved by the characterizing feature of claim 1.

Since the valve surge arrester which is provided in any case is generally shared between the valve sections, control capacitors are no longer required for each valve section. This considerably reduces the value of the switch-on capacitance of a valve as a result of which, in addition, the saturable inductors which are provided for each valve section can be made smaller. As a result of the partial integration of a valve surge arrester in its valve sections, the valve is limited at a point with respect to overvoltages which occur, caused by stray capacitances, without previously balancing this overvoltage that occurs.

In a second embodiment of a valve according to the invention of a converter for an HVDC transmission system, the existing valve surge arrester is completely integrated in the valve. This means that the valve surge arrester is shared between its valve sections. This additionally results in a reduction in the space requirement for a valve tower.

In one advantageous embodiment of a valve according to the invention of a converter for an HVDC transmission system, the surge arresters which are integrated in the valve sections of this valve are liquid-cooled. This allows them to be connected to the existing cooling system of the valve, thus making it possible to dispense with separate surge arrester cooling.

In order to explain the invention further, reference is made to the drawing, in which a plurality of embodiments of a valve of a converter for an HVDC transmission system are illustrated schematically, and in which:

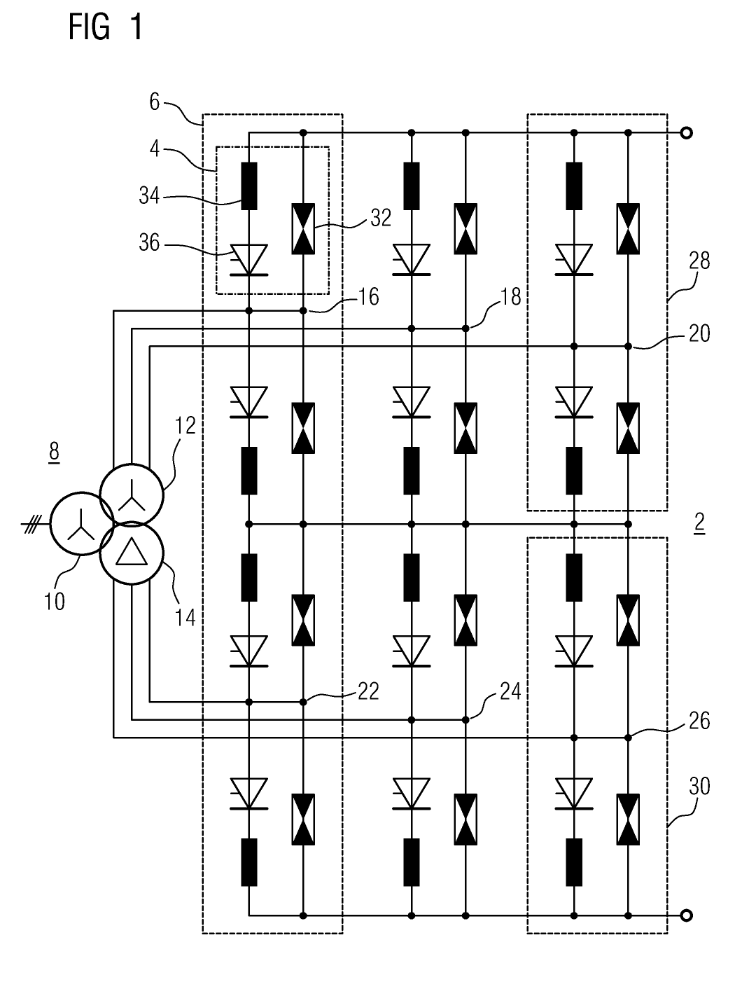

FIG. 1 shows an equivalent circuit of a converter for an HVDC transmission system according to the prior art,

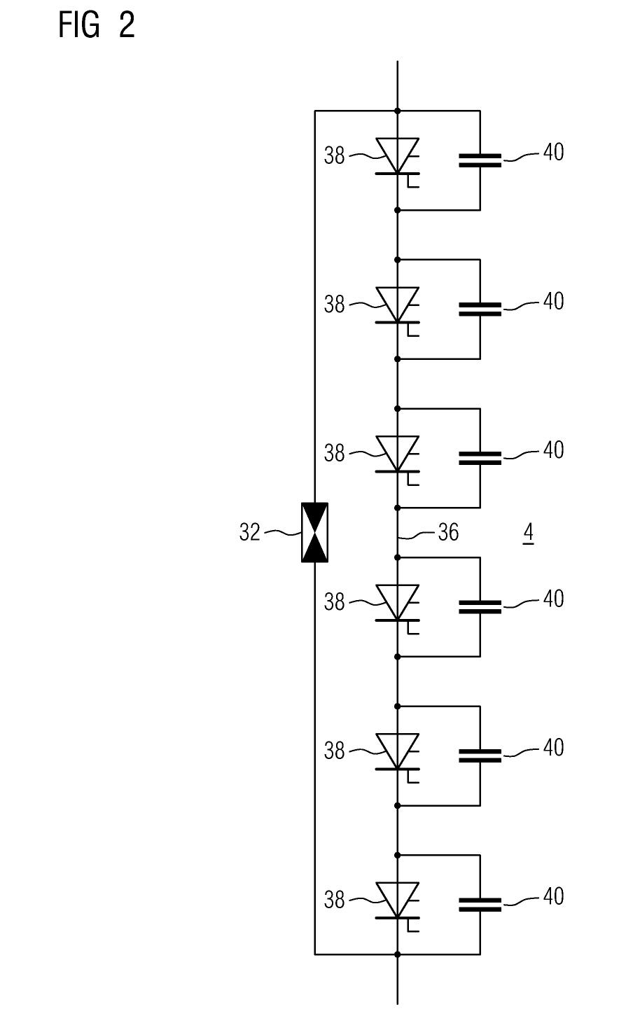

FIG. 2 shows an equivalent circuit of a valve for the converter shown in FIG. 1,

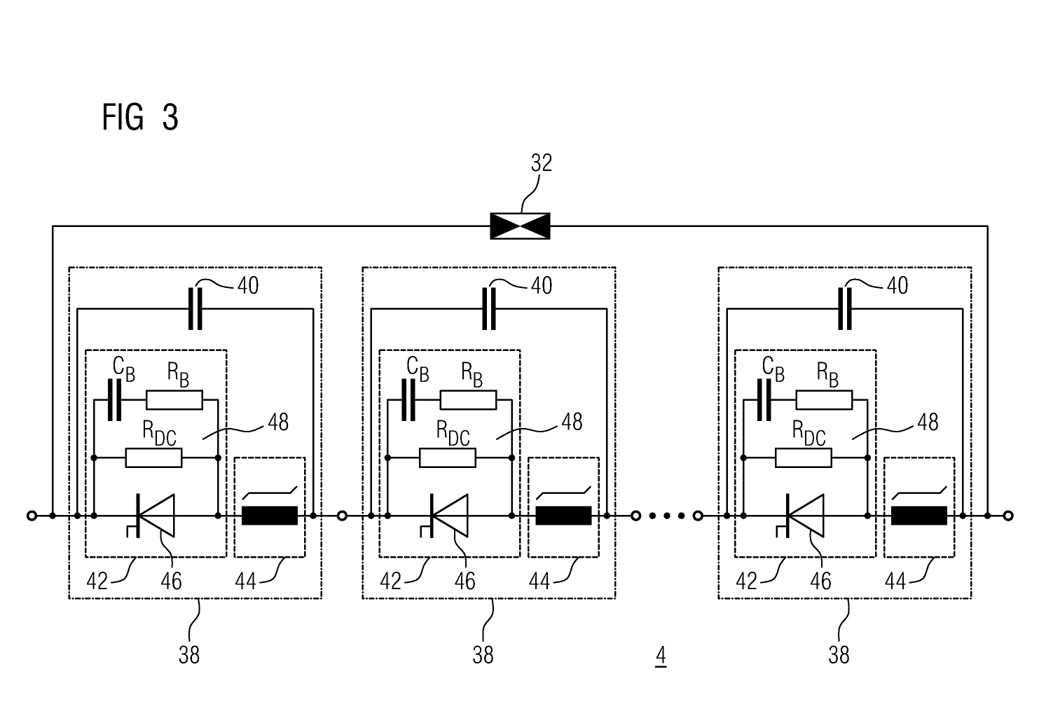

FIG. 3 shows a circuit diagram of a valve for the converter shown in FIG. 1,

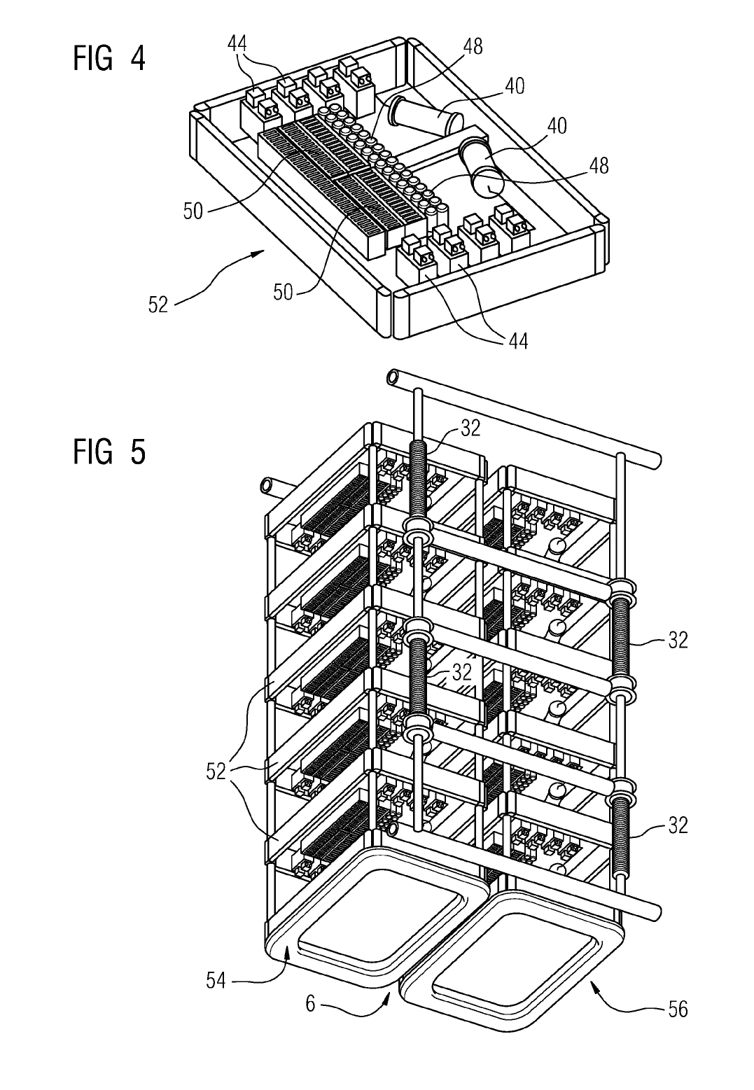

FIG. 4 shows a thyristor module for the converter shown in FIG. 1,

FIG. 5 shows a configuration of the converter shown in FIG. 1, and

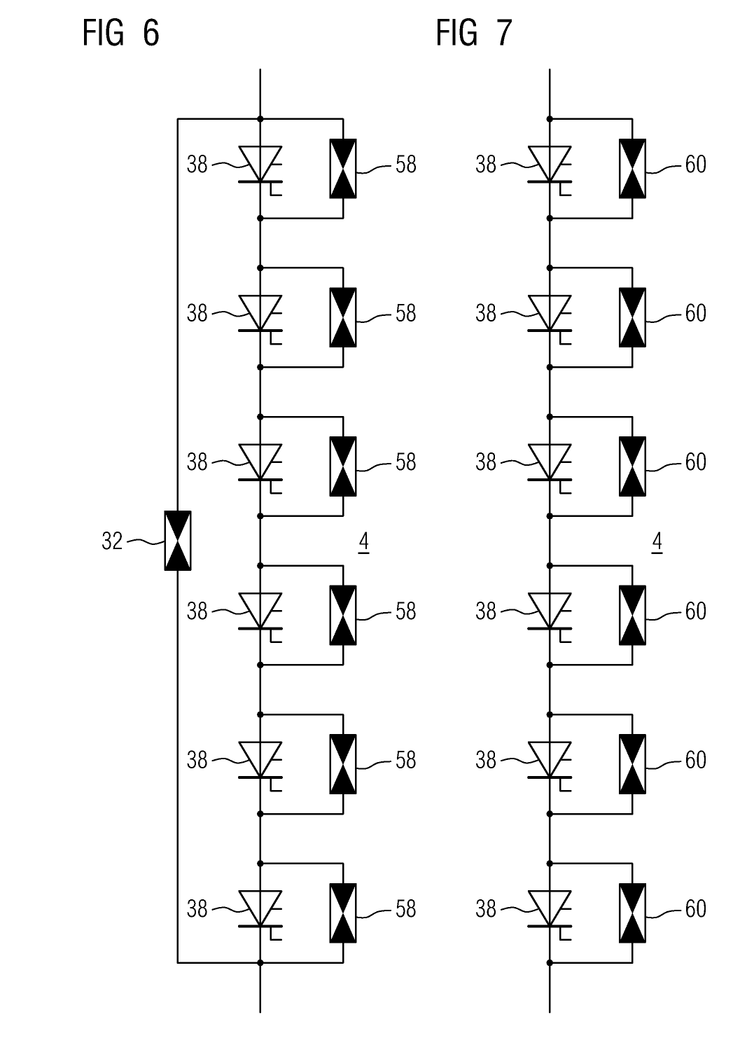

FIG. 6 shows an equivalent circuit of a first embodiment of a valve according to the invention for a converter for an HVDC transmission system while, in contrast,

FIG. 7 shows a second embodiment of a valve according to the invention.

According to the equivalent circuit of a converter 2 for a high-voltage direct-current transmission system (HVDC transmission system), which is not illustrated in any more detail, each phase of this converter 2 has four valves 4 which are electrically connected in series. A phase valve 6 such as this is referred to as a quadruple valve. On the AC voltage side, this converter 2 is connected to a power supply system by means of a transformer 8. This transformer 8 has one primary winding 10 and two secondary windings 12 and 14. The primary winding 10 and the secondary winding 12 are each connected in star, whereas the secondary winding 14 is connected in delta. Each output of one phase of a secondary winding 12 or 14 is electrically conductively connected to a respective AC-voltage side input 16, 18, 20 or 22, 24, 26 of a partial phase valve 28 or 30, comprising two valves 4 which are electrically connected in series. The harmonic load on the power supply system is low because of the use of a transformer 8 with two secondary windings 12 and 14 connected in star and delta.

According to this equivalent circuit of a converter 2 for an HVDC transmission system, each valve 4 has a valve surge arrester 32, an equivalent inductance 34 and an equivalent thyristor 36. According to FIG. 2, this equivalent thyristor 36 has six valve sections 38, which are each represented by a thyristor circuit diagram. A control capacitor 40 is electrically connected in parallel with each valve section 38. The value of each control capacitor 40 must be chosen to be sufficiently high that the voltage distribution is governed by it and not by the existing stray capacitances. A typical value for a control capacitor for a 500 kV HVDC transmission valve 4 is, for example, 6 nF per valve section 38, that is to say, when there are six valve sections 38, the value of each control capacitor 40 is 1 nF per valve 4.

FIG. 3 shows a circuit diagram of a valve 4 for a converter 2 for an HVDC transmission system in more detail. According to the equivalent circuit of the valve 4 shown in FIG. 2, this valve 4 has six valve sections 38, only three valve sections 38 of which are illustrated, for the sake of clarity. In addition to the control capacitor 40, each valve section 38 also has a plurality of thyristor spaces 42 and a plurality of saturable inductors 44. Of these, in each case only one is illustrated per valve section 38. Each thyristor space 42 has a thyristor 46, with a circuitry network 48 being connected in parallel with each of them. By way of example, a valve 4 for a 500 kV converter 2 comprises six valve sections 38, which each have thirteen thyristor spaces 42. This valve 4 therefore has 78 thyristors 46.

As shown in FIG. 4, which illustrates the configuration of a so-called thyristor module 52 in more detail, the thyristors 46 of each valve section 38 are electrically connected in series, and are arranged with their cooling modules together in a clamping fastener 50. As shown in this illustration, on the one hand the circuitry networks 48 and on the other hand the thyristor drives are arranged physically parallel to the clamping fastener 50. This illustration also shows that a thyristor module 52 accommodates further components of two valve sections 38. These components include the saturable inductors 44, with four of them per valve section 38, and the control capacitors 40, with in each case one per valve section 38. A valve 4 which is subdivided into six valve sections 38 is thus provided by means of three thyristor modules 52. This means that a quadruple valve 6 of the converter 2 shown in FIG. 1 has twelve such thyristor modules 52.

FIG. 5 illustrates the configuration of a quadruple valve 6 such as this in more detail. Its twelve thyristor modules 52 are distributed between two valve towers 54 and 56. These thyristor modules 52 each form one level of a valve tower 54 and 56. The associated valve surge arresters 32 are arranged by means of a mounting structure physically alongside the two valve towers 54 and 56. This illustration shows the physical extent of a valve surge arrester 32 such as this.

FIG. 6 shows an equivalent circuit of a first embodiment of a valve 4 according to the invention in more detail. In comparison to the equivalent circuit shown in FIG. 2, the valve 4 according to the invention no longer has any control capacitors 40. The function of the voltage limiting of these control capacitors 40 is now carried out by valve section surge arresters 58. These valve section surge arresters 58 are of such a size that a part of the previous valve surge arrester 32 is now formed by them. One surge arrester with a lower rating is therefore required as the valve surge arrester 32. As a result of the lack of the control capacitors 40 of a valve 4, the existing stray capacitances, which differ depending on the valve section under consideration, now once again govern the voltage distribution along the valve 4. If a voltage which exceeds the arrester voltage occurs on a valve section 38 of the valve 4, then the corresponding valve section surge arrester 58 conducts, and thus limits this voltage that has occurred to a predetermined value. The partial integration of the valve surge arrester 32 in its individual valve sections 38 means that control capacitors 40 are no longer required, thus reducing the value of the switch-on capacitance of each valve section 38. The value of the inductance of each saturable inductor 44 of a valve section 38 is thus also reduced.

In a second embodiment of a valve 4 according to the invention for a converter 2 for an HVDC transmission system, the valve surge arrester 32 is completely integrated in its valve sections 38. As shown in the equivalent circuit in FIG. 7, each valve section 38 has a valve section surge arrester 60. These valve section surge arresters 60 in each case have a higher rating than the valve section surge arresters 58 in the embodiment shown in FIG. 6, since the power which the valve surge arrester 32 can withstand is now applied completely by these valve section surge arresters 60. Since, in this embodiment of the valve 4, there is no longer a requirement for valve surge arresters 32, there is also no longer any need for a mounting frame for the valve surge arresters 32, thus reducing the physical dimensions of the two valve towers 54 and 56 for the configuration of the quadruple valve 6 as shown in FIG. 5.

1-5. (canceled)

6. A valve of a converter in a high-voltage direct-current transmission system, comprising:
a plurality of valve sections each having a plurality of thyristors electrically connected in series;
a surge arrester electrically connected in parallel with the valve; and
a surge arrester electrically connected in parallel with each of said valve sections.

7. The valve according to claim 6, wherein said surge arresters are liquid-cooled surge arresters.

8. The valve according to claim 6, wherein said surge arresters of two valve sections are integrated in a common thyristor module accommodating said two valve sections.

9. A valve of a converter in a high-voltage direct-current transmission system, comprising:
a plurality of valve sections each having a plurality of thyristors electrically connected in series; and
a surge arrester electrically connected in parallel with each valve of said valve sections.

10. The valve according to claim 9, wherein said surge arresters are liquid-cooled surge arresters.

11. The valve according to claim 9, wherein said surge arresters of two valve sections are integrated in a common thyristor module accommodating said two valve sections.

12. A valve of a converter in a high-voltage direct-current transmission system, comprising:
a plurality of valve sections each having a plurality of thyristors electrically connected in series; and
a surge arrester electrically connected in parallel with each thyristor of said plurality of thyristors.

13. The valve according to claim 12, wherein said surge arresters are liquid-cooled surge arresters.
